(19) United States
(12) Patent Application Publication
(10) Pub. No.: US 2024/0186912 A1
(43) Pub. Date: Jun. 6, 2024

(54) VOLTAGE BOOSTING RECTIFIER CIRCUIT

(71) Applicant: Eaton Intelligent Power Limited, Dublin (IE)

(72) Inventors: Tengyu Wu, Guangdong (CN); Huaqiang Li, Menomonee Falls, WI (US); Xiaoling Li, Guangdong (CN); Belly Lei, Guangdong (CN)

(21) Appl. No.: 18/286,483

(22) PCT Filed: May 26, 2022
(86) PCT No.: PCT/EP2022/025246

§ 371 Date: Oct. 11, 2023

Related U.S. Application Data
(60) Provisional application No. 63/195,317, filed on Jun. 1, 2021.

(51) Int. Cl. H02M 7/06; H02M 7/217

(52) U.S. Cl. CPC H02M 7/06; H02M 7/217

(57) ABSTRACT

An apparatus includes an energy storage system electrically connected across a bus. the energy storage system comprising: a first energy storage element. and a second energy storage element electrically connected to the first energy storage element at an energy node that is between the first energy storage element and the second energy storage element: and an energy filter system electrically connected to the energy node. The energy filter system is configured to electrically connect to one phase of a multi-phase alternating current (AC) power system.

### CROSS-REFERENCE TO RELATED APPLICATION

This application claims the benefit of U.S. Provisional Application No. 63/195,317, filed on Jun. 1, 2021 and titled VOLTAGE BOOSTING RECTIFIER CIRCUIT, which is incorporated herein by reference in its entirety.

### TECHNICAL FIELD

This disclosure relates to a voltage boosting rectifier circuit.

### BACKGROUND

A rectifier circuit converts alternating current (AC), which periodically reverses direction, to direct current (DC), which flows in only one direction.

### SUMMARY

In one aspect, an apparatus includes an energy storage system electrically connected across a bus, the energy storage system including: a first energy storage element, and a second energy storage element electrically connected to the first energy storage element at an energy node that is between the first energy storage element and the second energy storage element; and an energy filter system electrically connected to the energy node. The energy filter system is configured to electrically connect to one phase of a multi-phase alternating current (AC) power system.

Implementations may include one or more of the following features.

The energy filter system may be configured to filter an electrical current that flows to the energy storage system.

The first energy storage element may be a first capacitor, the second energy element may be a second capacitor, and the energy filter system may be an inductor. The inductor may be configured to electrically connect to a third phase of the AC power system, and the apparatus also may include a first switching module electrically connected to the energy storage system, and a second switching module electrically connected to the energy storage system. The first switching module may include a first input node that is configured to electrically connect to a first phase of the AC power system; and the second switching module may include a second input node that is configured to electrically connect to a second phase of the AC power system. The energy filter system may be configured to filter the electrical current that flows to the energy storage system such that the electrical current that flows in the first switching module and the second switching module are substantially the same. The first switching module may include a first switch electrically connected to a third switch at the first input node; and the second switching module may include a second switch electrically connected to a fourth switch at the second input node. Each of the first switch, the second switch, the third switch, and the fourth switch may include an anode and a cathode. The anode of the first switch may be electrically connected to a cathode of the third switch, an anode of the second switch may be electrically connected to a cathode of the fourth switch. The first switch may be a first diode, the second switch may be a second diode, the third switch may be a third diode, and the fourth switch be a fourth diode.

In another aspect, a rectifier system includes: a bus configured for connection to a load; a first switching module electrically connected to the bus, the first switching module including: a first switching element electrically connected to a first side of the bus; and a third switching element electrically connected to a second side of the bus and to the first switching element. The first switching element is electrically connected to the third switching element at a first input node that is between the first switching element and the third switching element. The system also includes a second switching module electrically connected to the bus, the second switching module including: a second switching element electrically connected to the first side of the bus; and a fourth switching element electrically connected to the second side of the bus and the second switching element. The second switching element is electrically connected to the fourth switching element at a second input node that is between the second switching element and the fourth switching element. The system also includes an energy storage system configured to be connected in parallel with the load. The energy storage system includes: a first energy storage element electrically connected to the first side of the bus; and a second energy storage element electrically connected to the second side of the bus and to the first energy storage element. The first energy storage element is electrically connected to the second energy storage element at an energy node that is between the first energy storage element and the second energy storage element. The energy storage system also includes an energy filter system electrically connected to the energy node. The first input node is configured to electrically connect to a first phase of an alternating current (AC) power system, the second input node is configured to electrically connect to a second phase of the AC power system, and the energy filter system is configured to electrically connect to a third phase of the AC power system.

Implementations may include one or more of the following features.

The first switching element may include a first diode, the second switching element may include a second diode, the third switching element may include a third diode, and the fourth switching element may include a fourth diode; the first energy storage element may include a first capacitor, and the second energy storage element may include a second capacitor; and the energy filter system may include an inductor. In some implementations, the first input node is electrically connected to an anode of the first diode and to a cathode of the third diode, the second input node is electrically connected to an anode of the second diode and to a cathode of the fourth diode, the first capacitor is electrically connected to a cathode of the first diode and to a cathode of the second diode, and the second capacitor is electrically connected to an anode of the third diode and to an anode of the fourth diode. The first input node may be electrically connected to a cathode of the first diode and to an anode of the third diode, the second input node may be electrically connected to a cathode of the second diode and to an anode of the fourth diode, the first capacitor may be electrically connected to an anode of the first diode and to an anode of the second diode, and the second capacitor may be electrically connected to a cathode of the third diode and to a cathode of the fourth diode. The first capacitor and the second capacitor may have the same capacitance value.

In some implementations, the voltage across the energy storage system is at least two times greater than a line-line input voltage, where the line-line input voltage is a voltage between any two of the three phases of the AC power system.

In some implementations, in operational use, a first phase input current flows at the first input node, a second phase input current flows at the second input node, and a third phase input current flows at the energy filter system; and the energy filter system is configured to reduce a difference among an RMS value of the first phase input current, an RMS value of the second phase input current, and an RMS value of the third phase input current.

Moreover, in some implementations, in operational use, an AC current flows in each of the first switching element, the second switching element, the third switching element, and the fourth switching element during a single power cycle; and the energy filter system is configured such that substantially the same amount RMS current flows in each of the first switching element, the second switching element, the third switching element, and the fourth switching element during the single power cycle.

In another aspect, a method of determining a final inductance value of an inductor for a rectifier circuit includes: accessing an initial inductance value of the inductor; and determining a first voltage across a capacitor at a first time. The capacitor is electrically connected to the inductor and to a plurality of switching modules that are each configured to be electrically connected to a phase of an alternating current (AC) power system. The method also includes determining a second voltage across the capacitor at a second time that occurs after the first time; and determining a difference between the first voltage and the second voltage. If the difference between the first voltage and the second voltage is outside a pre-determined range, the method further includes: reducing the first voltage; and determining a difference between two additional voltages after reducing the first voltage. If the difference between the first voltage and the second voltage is within the pre-determined range, the method further includes: comparing an electrical current in each switching module to the electrical current in the other switching modules. If the root-mean-square (RMS) electrical current in the switching modules is similar to within a threshold difference, the initial inductance value is provided as the final inductance value; and if the RMS electrical current in the switching module is not similar to within the threshold difference, the initial inductance value is reduced until the RMS electrical current in the switching modules is similar to within the threshold difference. Implementations may include one or more of the following features. The pre-determined range may be a range of values between a first number that is less than zero and a second number that is greater than zero, and the threshold difference may be a non-zero number. In some implementations, the pre-determined range includes only zero, and the threshold difference is zero

The first voltage may be the voltage across the capacitor at a beginning of a power cycle of the AC power system, and the second voltage may be the voltage across the capacitor at an end of the power cycle of the AC power system.

The two additional voltages may be the reduced first voltage another instance of the second voltage.

Implementations of any of the techniques described herein may include an apparatus, a device, a system, and/or a method. The details of one or more implementations are set forth in the accompanying drawings and the description below. Other features will be apparent from the description and drawings, and from the claims.

### DRAWING DESCRIPTION

FIG. 1 is a block diagram of a system that includes an example of a balanced rectifier circuit.

FIG. 2 is a block diagram of a system that includes an example of an unbalanced rectifier circuit.

FIG. 3A is an example of line-line input voltage as a function of time.

FIG. 3B is an example of voltage across a capacitor in an unbalanced rectifier circuit as a function of time.

FIG. 3C is an example of output voltage of an unbalanced rectifier circuit as a function of time.

FIG. 3D is an example of current that flows in diodes of an unbalanced rectifier circuit as a function of time.

FIG. 4A is a block diagram of a system that includes an example of a balanced rectifier circuit.

FIGS. 4B-4D are examples of current flow in the balanced rectifier circuit of FIG. 4A.

FIG. 5 is a flow chart of an example of a process for determining an inductance value of an inductor in a balanced rectifier circuit.

FIG. 6 is a block diagram of a computation system that may be used to determine an inductance value of an inductor in a balanced rectifier circuit.

FIG. 7A is an example of line-line input voltage as a function of time.

FIG. 7B is an example of voltage across a capacitor in a balanced rectifier circuit as a function of time.

FIG. 7C is an example of output voltage of a balanced rectifier circuit as a function of time.

FIG. 7D is an example of current that flows in diodes of an balanced rectifier circuit as a function of time.

### DETAILED DESCRIPTION

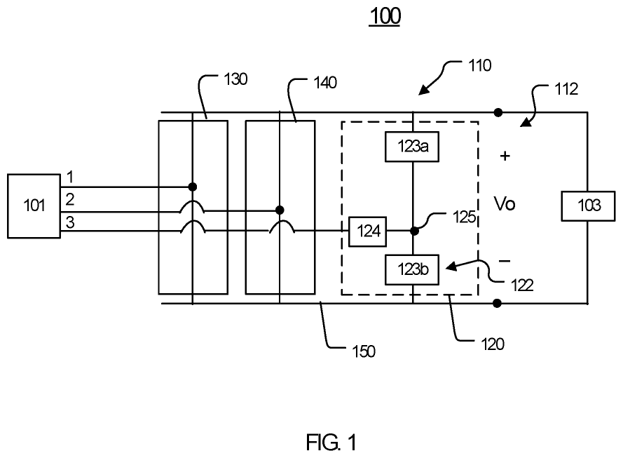

FIG. 1 is a block diagram of a system 100. The system 100 includes a rectifier circuit 110, which includes an apparatus 120, a first switching module 130, and a second switching module 140. The apparatus 120 is shown surrounded by a dashed line boundary for labeling purposes. The dashed line boundary does not necessarily represent a physical item. The apparatus 120 includes an energy storage system 122 that is electrically connected across a bus 150, and an energy filter system 124. The energy storage system 122 includes a first energy storage element 123a and a second energy storage element 123b. The rectifier circuit 110 produces a boosted voltage Vo at an output 112. The output 112 is connected to a load 103. The load 103 may be, for example, an inverter that converts the DC output of the rectifier circuit 110 into an AC motor drive signal that is provided to a motor (not shown). As discussed below, the configuration of the apparatus 120 results in a larger boosted voltage Vo than is possible with a traditional full-bridge rectifier circuit. In this way, the apparatus 120 improves the performance of the system 100.

The system 100 also includes a three-phase alternating current (AC) power system 101. The three phases of the AC power system 101 are referred to as phase 1, phase 2, and phase 3. In operational use, the rectifier circuit 110 is electrically connected to the AC electrical power system 101. Specifically, the first switching module 130 is electrically connected to phase 1, the second switching module 140 is electrically connected to phase 2, and an energy filter system 124 of the apparatus 120 is electrically connected to phase 3. The AC power system 101 is any type of device or system capable of providing multi-phase electrical power. The AC electrical source may be, for example, a high-voltage electrical distribution system such as an AC electrical grid that distributes AC electrical power having a fundamental frequency of, for example, 50 or 60 Hertz (Hz) and has an operating voltage of up to 690V. In another example, the AC power system 101 is a generator.

A traditional full-bridge rectifier circuit for a three-phase power input (such as the AC power system 101) includes six diodes and produces an output voltage that is about 1.4 times greater than the line-line voltage of the AC power input. The line-line voltage of a multi-phase power input is the voltage between any two phases of the AC power input. To increase the output voltage of a traditional full-bridge rectifier, six controllable switches (such as six insulated gate transistors or IGBTs) may be used instead of the six diodes. However, the controllable switches require drive and/or control circuitry and add complexity and cost. Other options for increasing the output voltage of a traditional full-bridge rectifier include the single-switch boost and the only boost circuit, both of which include a controllable switch and are generally limited to low power applications.

On the other hand, the rectifier circuit 110 provides a simple and low-cost solution in which the boosted voltage Vo at the output 112 is greater than would be achieved with a traditional full-bridge rectifier. For example, the boosted voltage Vo may be about 2.8 times greater than the line-line voltage of the AC power system 101. In other words, the boosted voltage Vo may be about 2.8 times greater than the voltage between any two of the phases 1, 2, and 3. Thus, the rectifier circuit 110 provides a greater increase in output voltage than the traditional full-bridge rectifier. It is desirable to increase the boosted voltage Vo (the voltage at the output 112). For example, in some industrial applications, additional devices, such as electromagnetic interference (EMI) filters and/or AC reactors are connected to the input of the rectifier circuit 110, and the input of the rectifier circuit 110 may be electrically connected to the AC power system 101 via a long cable. As noted above, the output 112 of the rectifier circuit 110 may be connected to an inverter (not shown) that converts the DC output of the rectifier circuit 110 into an AC motor drive signal that is provided to a motor (not shown). Load reactors and/or filters (such as a sine wave or dv/dt filter) may be electrically connected between the output of the inverter and the motor. The long cable, the load reactors, and/or filters are examples of additional elements that may cause voltage drops for the load 103, an these voltage drops may be detrimental to the end-user's application. For example, the load 103 may be an inverter that provides an AC signal to a motor. In this example, voltage drops for the inverter result in the motor entering the field weakening region at the rated frequency, which may cause a complete or partial loss of precision control of the motor. By providing a larger voltage Vo at the output 112, the rectifier circuit 110 mitigates or avoids voltage drops at the load 103. Moreover, the rectifier circuit 110 includes simple and low-cost components. For example, each energy storage element 123a and 123b may be a capacitor, the energy filter system 124 may be an inductor, and each of the switching modules 130 and 140 may include two diodes. Thus, the rectifier circuit 110 provides a greater voltage increase than a traditional full-bridge rectifier but does not necessarily include complex, controllable components. Therefore, the rectifier circuit 110 offers an inexpensive, relatively simple, and reliable rectification circuit for use with a multi-phase AC power input (such as the power system 101). As discussed further below, when the rectifier circuit 110 is electrically connected to the AC power system 101 and to the load 103, the energy filter system 124 filters the electrical current that flows to the energy storage system 122 such that the electrical current that flows in the first switching module 130 is the same as the electrical current that flows in the second switching module 140. In this way, the energy filter system 124 balances the currents that flow in the switching modules 130 and 140.

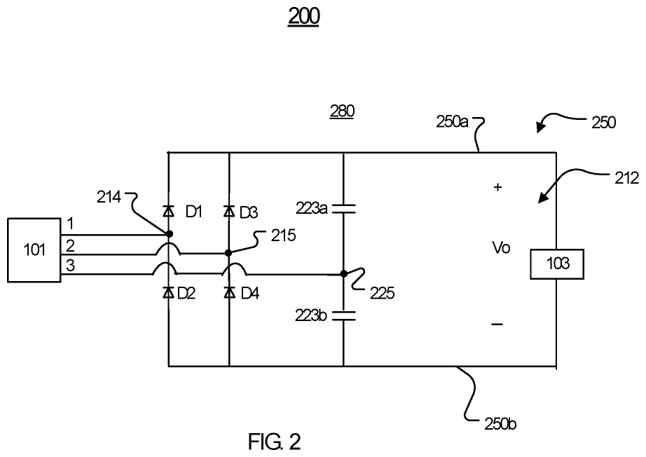

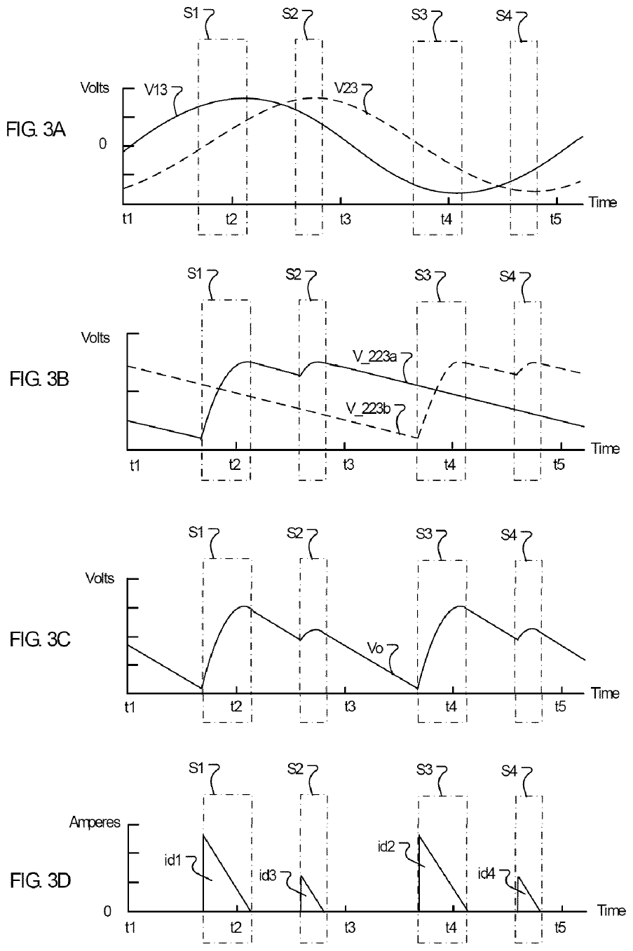

To further illustrate the configuration and performance of the rectifier circuit 110 and the energy filter system 124, an unbalanced rectifier circuit 280 is discussed with respect to FIGS. 2 and 3A-3D. FIG. 2 is a block diagram of a system 200 that includes the unbalanced rectifier circuit 280. The unbalanced rectifier circuit 280 does not include the energy filter system 124.

The unbalanced rectifier circuit 280 includes four diodes D1, D2, D3, and D4, each of which includes an anode and a cathode. Each of the diodes D1, D2, D3, and D4 conducts current when the voltage at the anode of that diode is greater than the voltage of the cathode of that diode by a threshold voltage amount but otherwise does not conduct an appreciable amount of current. The threshold voltage amount depends on the properties and construction of the diode and may be, for example, 0 to 0.7 volts (V).

The cathode of the diode DI and the cathode of the diode D3 are electrically connected to a first side 250a of a bus 250. The cathode of the diode D2 is electrically connected to the anode of the diode DI at a first node 214. The cathode of the diode D4 is electrically connected to the anode of the diode D3 at a second node 215. The anode of the diode D2 and the anode D4 are electrically connected to a second side 250b of the bus 250. A capacitor 223a is electrically connected to the first side 250a of the bus 250 and to a capacitor 223b at an energy node 225. The capacitor 223b is electrically connected to the capacitor 223a and to the second side 250b of the bus 250.

The unbalanced rectifier circuit 280 is shown connected to the AC power system 101. The operation of the unbalanced rectifier circuit 280 is discussed next with reference to four distinct statuses S1, S2, S3, and S4 that occur in each power frequency cycle. A power frequency cycle occurs during the time between two adjacent peaks of an input line-line voltage signal (for example, V13 or V23). This time is also referred to as the period of the input line-line voltage signal. The statuses S1, S2, S3, and S4 are shown in FIGS. 3A-3D. FIG. 3A shows the line-line voltages V13 (solid line) and V23 (dashed line) as a function of time The line-line voltage V13 is the voltage between phase 1 and phase 3. The line-line voltage V23 is the voltage between phase 2 and phase 3. The x-axis is in units of time, for example, seconds. The time between the times t1 and t5 corresponds to a period of the line-line voltage V13. The amount of time between t1 and t5 depends on the frequency of the input voltage. For example, when the input voltage has a frequency of 50 Hz, the period (and the time between t1 and t5) is 0.02 s. When the input voltage has a frequency of 60 Hz, the period is 0.0167 s. The y-axis represents the amplitude of the voltages V13 and V23. The amplitude of the voltages depends on the utility voltage. The peak utility voltage may be, for example, 115 V for each phase or 230 V for each phase.

FIG. 3B shows the voltage across the capacitor 223a (solid line) and the capacitor 223b (dashed line) as a function of time for the unbalanced rectifier circuit 280. FIG. 3C is the output voltage Vo as a function of time for the unbalanced rectifier circuit 280. The values of the voltages shown in FIGS. 3B and 3C depend on the properties of the components of the unbalanced rectifier circuit 280, but the peak voltage across each of the capacitors 223a and 223b is less than the peak output voltage Vo. FIG. 3D shows the magnitude of currents id1, id2, id3, and id4 as a function of time for the unbalanced rectifier circuit 280. The units of the currents id1, id2, id3, id4 may be, for example, amperes. The value of the currents id1, id2, id3, id4 depend on the components of the unbalanced rectifier circuit 280 and the characteristics of the power system 101. The currents id1, id2, id3, and id4 are the currents that flow in the diodes D1, D2, D3, and D4, respectively. Specifically, in the configuration shown in FIG. 2, the current id1 flows through the node 214, the diode D1, the capacitor 225a, and the node 225. The current id2 flows through the node 225, the capacitor 223b , the diode D2, and the node 214. The current id3 flows through the node 215, the diode D3, the capacitor 223a, and the node 225. The current id4 flows through the node 225, the capacitor 223b , the diode D4, and the node 215. The x-axis is the same in each of FIGS. 3A-3D.

In the status S1, V13 >V23 >0, the diode D1 conducts current, and the capacitor 223a is charged by V13 through the diode D1. In the status S2, V23>V13>0, the diode D3 conducts current, and the capacitor 223a is charged by V23 through the diode D3. In the status S3, 0>V23 >V13 , the diode D2 conducts current, and the capacitor 223b is charged by V13 through the diode D2. In the status S4, 0>V13 >V23, the diode D4 conducts current, and the capacitor 223b is charged by V23 through the diode D4.

Accordingly, in a single cycle, each capacitor 223a and 223b is charged by V13 and V23. In the example of FIGS. 3A-3D, the phase angle of adjacent peak waves of phase 1, phase 2, and phase 3 is 120° , the phase angle of adjacent peak waves of the line-line voltage V13 and the line-line voltage V23 is 60° , and the process of charging and discharging the capacitors 223a and 223b is asymmetric. Specifically, the charging currents of V13 (status S1 and status S3) are larger than those of V23 (status S2 and status S4). This results in the currents id1, id2, id3, id4 having different amplitudes and different RMS values. For example, the peak value of the currents id1 and id3 may be about 140 A, while the peak value of the currents id2 and id4 may be about 50 A.

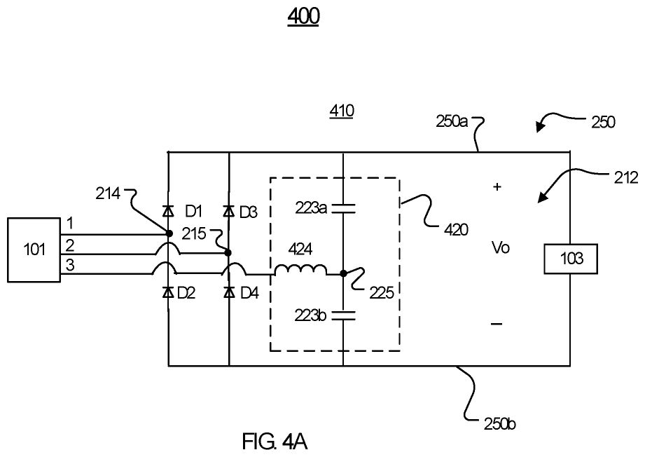

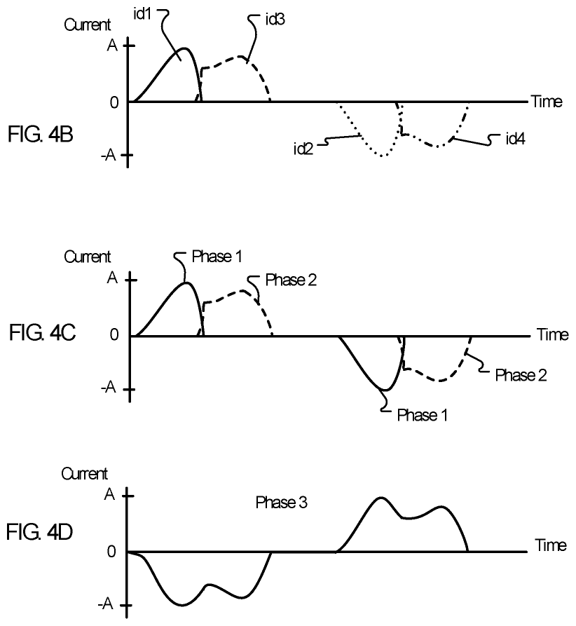

On the other hand, and referring to FIG. 4A, a rectifier circuit 410 includes an inductor 424 that balances the V13 and V23 charging currents. FIG. 4A is a block diagram of a system 400 that includes the rectifier circuit 410 and the AC power system 101. The rectifier circuit 410 is an example of an implementation of the rectifier circuit 110 (FIG. 1). The rectifier circuit 410 includes all of the components of the unbalanced rectifier circuit 280, but the rectifier circuit 410 also includes the inductor 424. The inductor 424 is electrically connected between the energy node 225 and phase 3 of the power system 101. The inductor 424 stores energy when there is an increase in the current that flows through one of the diodes D1, D2, D3, D4. The inductor 424 releases energy to the capacitors 223a and 223b when there is a decrease in the current that flows in one of the diodes D1, D2, D3, D4. In this way, the inductor 424 balances the discrepancy between the charging currents of V13 and V23 such that the currents id1, id2, id3, and id4 that flow in the respective diodes D1, D2, D3, and D4 are the same or nearly the same. The amount of inductance of the inductor 424 that achieves the balance may be determined using the process 500, which is discussed below.

The operation of the rectifier circuit 410 is as follows, with reference to the four distinct statuses S1, S2, S3, and S4 that occur in each power frequency cycle. In the status S1, V13>V23>0, the diode DI conducts current, and the capacitor 223a is charged by V13 through the diode D1 and the inductor 424. In the status S2, V23>V13>0, the diode D3 conducts current, and the capacitor 223a is charged by V23 through the inductor 424 and the diode D3. In the status S3, 0>V23>V13 the diode D2 conducts current, and the capacitor 223b is charged by V13 through the diode D2 and the inductor 424. In the status S4, 0 >V13 >V23, the diode D4 conducts current, and the capacitor 223b is charged by V23 through the inductor 424 and the diode D4. Thus, the capacitors 223a and 223b are charged by V13 and V23, and also with energy stored in the inductor 424 such that the currents id1, id2, id3, and id4 are balanced in the rectifier circuit 410. The output voltage (Vo) of the rectifier circuit 410 is about 2.8 times greater than the line-line input voltage of the power system 101. FIGS. 4B-4D show an example of simulated current flow in the rectifier circuit 410 as a function of time for a single power cycle when the input voltage was 230 Vac, the input frequency was 50 Hz, and the load was 98 ohms. The x and y axes are the same for each of FIGS. 4B-4D. For example, the variable labeled A on FIGS. 4B-4D may be 30 amperes. FIG. 4B shows the currents id1, id2, id3, id4 as a function of time; FIG. 4C shows the phase 1 and phase 2 input currents as a function of time. FIG. 4D shows the phase 3 input current as a function of time. As noted above, the inductor 424 is used to balance the currents id1, id2, id3, id4. The phase 1 input current is the current that flows in the diodes DI and D2. The phase 2 input current is the current that flows in the diodes D3 and D4. The phase 3 input current is the sum of the phase 1 and phase 2 input currents. In this example, the root-mean square (RMS) current of id1 and id2 was 8.14620 amperes, and the RMS current of id3 and id4 is 8.14759 amperes. The RMS currents id1, id2, id3, id4 are nearly the same and are considered balanced. The RMS phase 1 input current was the same as the RMS phase 2 input current. Each of the phase 1 and phase 2 input currents was 11.5206 amperes in this example. The phase 3 input current was 16.4303 amperes (about 1.4 times greater than the phase 1 and 2 input current).

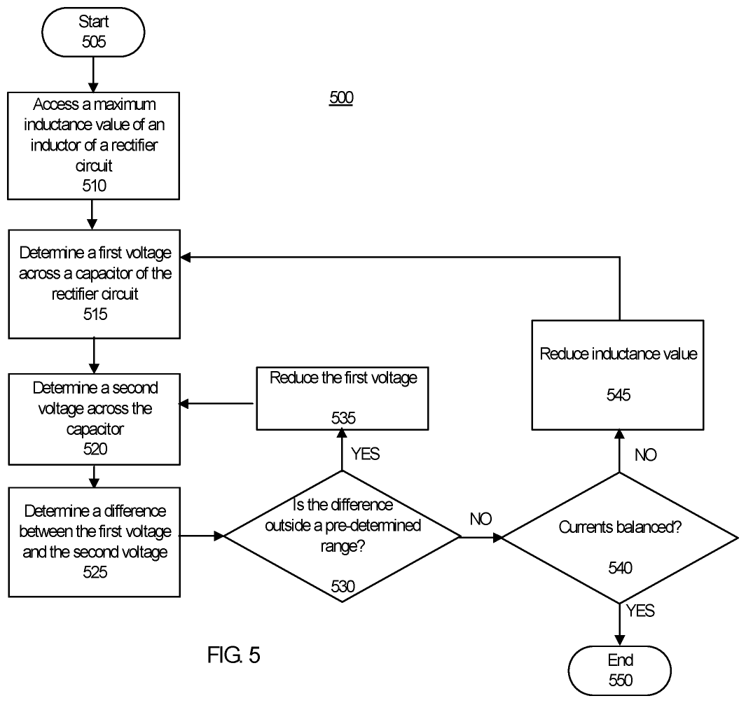

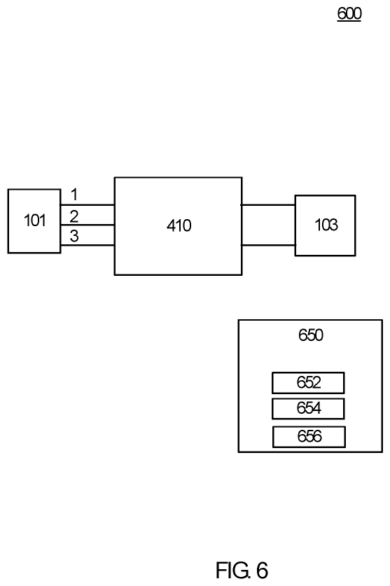

Although the phase 3 input current has a different RMS value than the phase 1 or phase 2 input currents, the configuration of the rectifier circuit 410 (which includes the inductor 424) results in the three phase input currents being more similar each other than is possible with the rectifier 210 (which lacks the inductor 424). This is because the RMS values of the currents id1, id2, id3, and id4 are the same or nearly the same due to the balancing provided by the inductor 424. As a result, the three phase input current waveforms are more balanced in the rectifier 410, which leads to improved performance as compared to a configuration that lacks the inductor 424. FIG. 5 is a flow chart of a process 500. The process 500 is used to determine a final inductance value of the inductor 424 (FIG. 4A). The process 500 may be performed prior to connecting the rectifier circuit 410 to an AC power system and prior to manufacturing and/or assembling the rectifier circuit 410. The process 500 provides an example in which the rectifier circuit 410 is designed to be connected to the AC power system 101. Specifically, the process 500 is discussed with respect to a system 600 (FIG. 6), which includes a calculation system 650 that determines the inductance value of the inductor 424 for a scenario in which the rectifier circuit 410 will be connected to the AC power system 101 and the load 103. An introduction to the iterative calculations and an overview of the system 600 are discussed before discussing the various elements of the process 500 in more detail.

The mathematical representations of the phase voltages of the phases 1, 2, and 3 of the power system 101 are shown in Equations (1)-(3):

V1=V_{M} sin(ω̅t) (1)

V2=V_{M} sin(ω̅t−120°) (2)

V3=V_{M} sin(ω̅t+120°) (3),

where V_{M} is the magnitude of the voltage in the power system 101. For example, in a 230V

(RMS) power system, V_{M} is 325V. The mathematical representations of the line-line voltages V13 and V23 are shown in Equations (4) and (5):

V13=\sqrt{3}V_{M} sin(ω̅t−30°) (4)

V23=\sqrt{3}V_{M} sin(ω̅t−90°) (5)

The mathematical representation of the voltage output (Vo) of the rectifier circuit 410 is given by Equation (6):

$$Vo = \{ \begin{matrix} & & \vert max ( V 13 , V23 ) \vert … 0 + 2 k π \leq ω t < 2 k π \\ 0 & … & \frac{4 π}{3} + 2 k π \leq ω t < \frac{6 π}{3} + 2 k π\end{matrix} . \qquad ( 6 )$$

During the charging process (when current flows into the capacitor 223a), the output voltage Vo of the rectifier circuit 410 is mathematically represented as shown in Equation (7):

$$Vo = L {C}_{223 a} \frac{{d}^{2} {V}_{C \_ 223 a}}{{dt}^{2}} + \frac{L}{Rload} \frac{{dV}_{C \_ 223 a}}{Rload} + {V}_{C \_ 223 a} , \qquad ( 7 )$$

where L is the inductance value of the inductor 424, C₂₂₃ₐ is the capacitance of the capacitor 223a, V_{C_223}a is the voltage across the capacitor 223a, and Rload is 0.5 times of the resistance in the load 103. During the discharging process, the voltage across the capacitor 223a is mathematically expressed as shown in Equation (8):

$${V}_{C \_ 223 a} = {V}_{C \_ 223 a} {e}^{\frac{- t}{( {R}_{loαd} ) C \_ 223 a}} , \qquad ( 8 )$$

where Rload is 0.5 times of the resistance of the load 103 (or other load to which the rectifier circuit 410 will be connected). Assuming that the voltage across the capacitor 223a (V_{C_223a}) is equal to the line-line voltage (V13 or V23) at the start of a power cycle, the value of V_{C_223a} at the end of the same power cycle is determined from Equations (7) and (8). When the rectifier circuit 410 is in a stable state, the value of V_{C_223a} at the beginning of the power cycle is the same as the value of V_{C_223a} at the end of the power cycle. By iteratively reducing V_{C_223a} until the value of V_{C_223a} at the beginning of the power cycle is the same as the value at the end of the power cycle, the stable state of the rectifier circuit 410 is determined. The process 500 includes such an iterative process, as discussed below.

The balanced frequency of the capacitor 223a and the inductor 424 is smaller than the fundamental frequency of the power system 101. Therefore, the maximum inductance value of the inductor 424 (L_max) is given by Equation (9):

$$L\_max = \frac{{( \frac{1}{2 π {f}_{input}} )}^{2}}{{C}_{223 a}} , \qquad ( 9 )$$

where fᵢₙₚᵤₜ is the fundamental frequency of the input power system in Hertz (Hz). In this example, the input power system is the AC power system 101; however, the input power system may be any AC power system to which the rectifier circuit 410 will be connected. With an iterative calculation (such as in the process 500), the inductance value for the inductor 424 is determined by beginning with L_max and reducing the inductance value until the root-mean-square (RMS) values of id1 and id3 are the same. Although equations (7), (8), and (9) include the capacitance value of the capacitor 223a (C_223a) and the voltage across the capacitor 223a (V_{C_223a}), the capacitance value of the capacitor 223b and the voltage across the capacitor 223b may be used in Equations (7), (8), and (9) instead. The process 500 implements the above discussion. Before discussing the process 500, the system 600, which includes an example of a calculation system 650 that is configured to perform the process 500, is discussed.

Referring also to FIG. 6, the system 600 includes the rectifier circuit 410, the power system 101, the load 103, and a calculation system 650. The calculation system 650 is a computing device that includes an electronic processing module 652, an electronic storage 654, and an input/output (I/O) interface 656.

The electronic processing module 652 includes one or more electronic processors. The electronic processors of the module 652 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 654 is any type of electronic memory that is capable of storing data and instructions in the form of computer programs or software, and the electronic storage 654 may include volatile and/or non-volatile components. The electronic storage 654 and the processing module 652 are coupled such that the processing module 652 is able to access or read data from and write data to the electronic storage 654.

The electronic storage 654 stores instructions that, when executed, cause the electronic processing module 652 to analyze data, perform computations, and/or retrieve or provide information. The electronic storage 654 may store instructions, for example, in the form of a computer program, that are used to implement the process 500. The electronic storage 654 also may store information about the components of the rectifier circuit 410, the load 103, and/or the power system 101. For example, the electronic storage 654 may store the capacitance values of the capacitors 223a and 223b, the fundamental frequency of the power system 101, the amplitude of the voltage of the power system 101, and the impedance of the load 103. The information about the power system 101, the rectifier circuit 410, and the load 103 provides a mathematical model or representation of these elements such that the inductance value of the inductor 424 may be calculated prior to assembling the rectifier circuit 410 and prior to installing the rectifier circuit 410. Moreover, the power system 101 and the load 103 are provided as examples, and the electronic storage 654 may store information about other power systems and/or other loads to which the rectifier circuit 410 may be connected. The electronic storage 654 also stores the maximum inductance value (L_max) of the inductor 424 and/or stores instructions that implement Equation (9) and calculate the value of L_max.

The I/O interface 656 may be any interface that allows a human operator and/or an autonomous process to interact with the calculation system 650. The I/O interface 656 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 656 also may allow communication without physical contact through, for example, an IEEE 802.11, Bluetooth, or a near-field communication (NFC) connection. The calculation system 650 may be, for example, operated, configured, modified, or updated through the I/O interface 656. For example, an operator may enter values of the various components of the rectifier circuit 410 via the I/O interface 656. In another example, the operator may enter information about the power system and/or load to which the rectifier circuit 410 will be connected. In the example shown in FIG. 6, the rectifier circuit 410 is to be connected to the AC power system 101 and the load 103.

The I/O interface 656 also may allow the system 600 to communicate with systems external to and remote from the system 600. For example, the I/O interface 656 may include a communications interface that allows communication between the calculation system 650 and a remote station (not shown), or between the calculation system 650 and a separate calculation apparatus. The remote station or the calculation apparatus may be any type of station through which an operator is able to communicate with the calculation system 650 without making physical contact with the calculation system 650. For example, the remote station may be a computer-based work station, a smart phone, tablet, or a laptop computer that connects to the calculation system 650 via a services protocol, or a remote control that connects to the calculation system 650 via a radio-frequency signal.

The calculation system 650 is provided as an example, and other computers, workstations, or machines that include an electronic processor may be used.

Returning to FIG. 5, the process 500 may be performed by one or more processors in the electronic processing module 652 or by another computing device. The process 500 starts (505) when an operator wishes to determine an inductance value for the inductor 424. The process 500 may be performed in a manufacturing or industrial facility that produces the rectifier circuit 410 to determine the value of the inductor 424 prior to assembling the rectifier circuit 410.

A maximum value of the inductor 424 is accessed (510). The maximum value of the inductor 424 (L_max) is determined according to Equation (9). A first voltage across a capacitor of the rectifier circuit 410 is determined (515). The capacitor may be the capacitor 223a or the capacitor 223b. In this example, the capacitor 223b is used for illustration purposes. The first peak voltage across the capacitor 223b is determined by multiplying the line-line input voltage of the AC power system 101 by the square root of 2 (1.414).

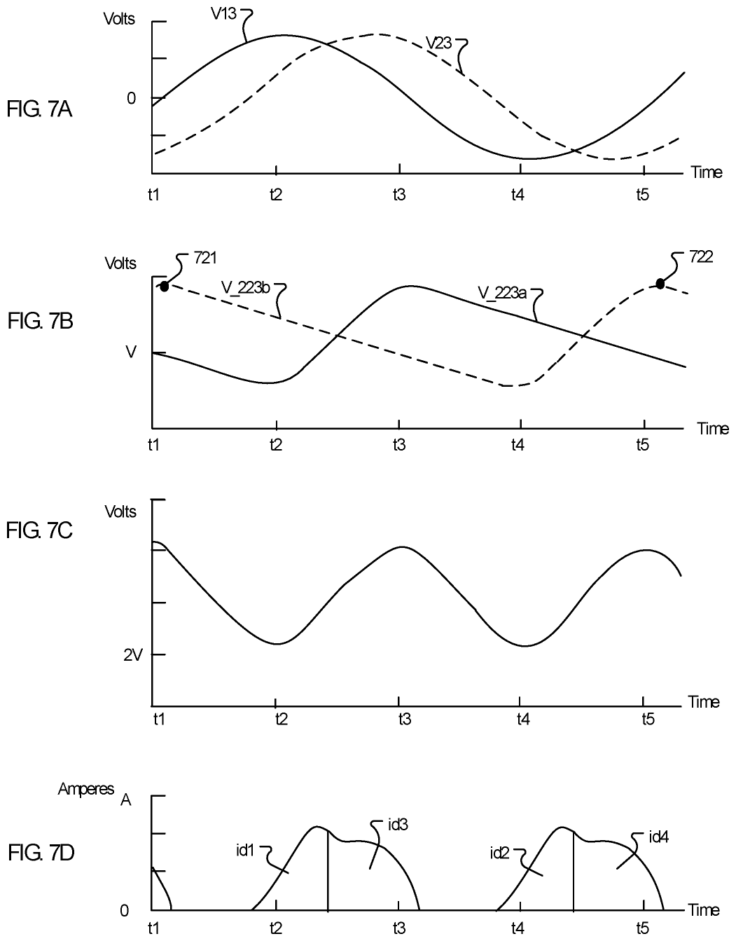

Referring also to FIGS. 7A-7D, data related to the rectifier circuit 410 for an example in which the fundamental frequency of the power system 101 is the same as the fundamental frequency of the power system 101 in FIGS. 3A-3D is shown. For example, the fundamental frequency may be 50 Hz or 60 Hz. FIG. 7A is V13 (solid line) and V23 (dashed line) as a function of time. FIG. 7B is the voltage across the capacitor 223a (solid line) and the capacitor 223b (dashed line). FIG. 7C is the output voltage Vo as a function of time. FIG. 7D shows the magnitude of id1, id2, id3, id4 as a function of time. FIGS. 7A-7D show approximately one power cycle. FIGS. 7A-7D have the same x-axis as FIGS. 3A-3D, respectively, and FIGS. 7A and 7D have the same y-axis as FIGS. 3A and 3D, respectively. The first peak voltage determined in (515) is labeled in FIG. 7B as 721. The y-axis on FIGS. 7B and 7C represents voltage. The voltage V labeled in FIG. 7B may be, for example, 300 Volts. The voltage 2V labeled in FIG. 7C is twice the voltage V. Continuing the example in which the voltage V is 300 Volts, the voltage 2V is 600 Volts. Thus, the output voltage Vo (shown in FIG. 7C) is greater than the voltage across the capacitor 223a and 223b (shown in FIG. 7B). The output voltage (Vo) is also greater than the line-line input voltage. For example, in an implementation in which the line-line input voltage is 230V, the output voltage Vo is 621V, which is about 2.7 times greater than the line-line input voltage.

Returning to FIG. 5, a second voltage across the capacitor is determined (520). The second voltage occurs after the first voltage. For example, the second voltage may be the voltage at the end of the same power cycle. In another example, the first and second voltage may be voltages that are not necessarily at the beginning and end of a particular power cycle but are adjacent peaks of the voltage across the capacitor. Continuing the example above, the second voltage is the voltage across the capacitor 223b the end of the power cycle. The second voltage is labeled 722 in FIG. 7B.

A difference between the first voltage and the second voltage is determined (525). As discussed above, the rectifier circuit 410 is in a stable state when the voltage across the capacitor 223a or the capacitor 223b is the same at the beginning of the power cycle and the end of the power cycle.

The difference determined in (525) is compared to a pre-determined range of values (530). The pre-determined range of values may be stored on the electronic storage 654. The pre-determined range of values may include, for example, a range of values that includes zero, such as 0.01 to −0.01. In some implementations, the range of values only contains the value of zero, indicating that difference will be considered to be outside of the pre-determined range of values unless the first and second voltages are the same. The range of values may be expressed in other ways. For example, the range of values may be expressed as a range of acceptable percentage change, such as a percentage change between −1% and 1%. These ranges are provided as examples, and other ranges of values may be used.

If the difference in voltages determined in (525) is outside of the range of values, the first voltage across the capacitor 223a or the capacitor 223b is reduced (535), the second voltage is determined again at (520), the difference is determined at (525), and the difference is again compared to the range of values (530). The amount that the first voltage is reduced may be determined based on design accuracy. The first voltage is reduced at (535) until the difference between the first and second voltages determined at (525) is within the range of values.

Returning to (530), if the difference is within the pre-determined range of values, the process 500 determines whether or not the RMS values of the currents id1, id2, id3, and id4 are the same. When the RMS values of the currents id1, id2, id3, and id4 are the same, the currents are balanced. To determine whether the currents id1, id2, id3, id4 are balanced, the RMS values of the currents are compared to each other. For example, the difference between the currents id1 and id3, and the difference between the currents id2 and id4 may be determined and compared to a threshold value. The threshold value may be, for example, zero, meaning that the currents id1, id2, id3, and id4 are the exactly the same. In some implementations, the threshold value is expressed as a percentage range, and may be, for example, −1% to 1%, meaning that the RMS values of the currents id1, id2, id3, id4 may differ from each other by as much as +/−1% and still be considered to be substantially the same. Other threshold values may be used depending on the needs of the particular application in which the rectifier 410 will be used. In the example shown in FIG. 4B, the RMS values of the currents id1 and id3 are about 0.13% different and are considered balanced or substantially the same. Moreover, a constant value (for example, 0.01 or 0.001) rather than a percentage may be used as the threshold value. The threshold value may be stored on the electronic storage 654. If the magnitude of either difference exceeds the threshold value, the currents are not considered to be balanced. If the currents id1, id2, id3, and id4 are balanced, the process 500 ends (550).

If the currents id1, id2, id3, and id4 are not balanced, then the inductance value for the inductor 424 is reduced (545). The amount by which the inductance value is reduced may be based on information stored on the electronic storage 654. For example, the inductance value may be reduced by a constant incremental amount that is stored on the electronic storage 654. In some implementations, the inductance value is reduced by a percentage of the current inductance amount, and the percentage reduction is based on, for example, the design accuracy.

The above implementations and other implementations are within the scope of the claims. For example, the rectifier circuit 410 may be configured with the opposite polarity than shown in FIG. 4A. In the opposite polarity configuration, the anode of the diode D1 and the anode of the diode D3 are electrically connected to the first side 250a, and the cathode of the diode D2 and the cathode of the diode D4 are electrically connected to the second side 250b. The cathode of the diode D1 is electrically connected to the anode of the diode D2. The cathode of the diode D3 is electrically connected to the anode of the diode D4.

What is claimed is:

1. An apparatus comprising:
an energy storage system electrically connected across a bus, the energy storage system comprising: a first energy storage element, and a second energy storage element electrically connected to the first energy storage element at an energy node that is between the first energy storage element and the second energy storage element; and
an energy filter system electrically connected to the energy node, wherein the energy filter system is configured to electrically connect to one phase of a multi-phase alternating current (AC) power system.

2. The apparatus of claim 1, wherein the energy filter system is configured to filter an electrical current that flows to the energy storage system.

3. The apparatus of claim 1, wherein the first energy storage element comprises a first capacitor, the second energy element comprises a second capacitor, and the energy filter system comprises an inductor.

4. The apparatus of claim 3, wherein the inductor is configured to electrically connect to a third phase of the AC power system, and the apparatus further comprises:
a first switching module electrically connected to the energy storage system, wherein the first switching module comprises a first input node that is configured to electrically connect to a first phase of the AC power system; and
a second switching module electrically connected to the energy storage system, wherein the second switching module comprises a second input node that is configured to electrically connect to a second phase of the AC power system.

5. The apparatus of claim 4, wherein the energy filter system is configured to filter the electrical current that flows to the energy storage system such that the electrical current that flows in the first switching module and the second switching module are substantially the same.

6. The apparatus of claim 5, wherein
the first switching module comprises a first switch electrically connected to a third switch at the first input node; and
the second switching module comprises a second switch electrically connected to a fourth switch at the second input node.

7. The apparatus of claim 6, wherein each of the first switch, the second switch, the third switch, and the fourth switch comprises an anode and a cathode.

8. The apparatus of claim 7, wherein an anode of the first switch is electrically connected to a cathode of the third switch, an anode of the second switch is electrically connected to a cathode of the fourth switch.

9. The apparatus of claim 8, wherein the first switch comprises a first diode, the second switch comprises a second diode, the third switch comprises a third diode, and the fourth switch comprises a fourth diode.

10. A rectifier system comprising:
a bus configured for connection to a load, the bus comprising: a first side and a second side;
a first switching module electrically connected to the bus, the first switching module comprising:
a first switching element electrically connected to the first side; and
a third switching element electrically connected to the second side and to the first switching element, wherein the first switching element is electrically connected to the third switching element at a first input node that is between the first switching element and the third switching element;
a second switching module electrically connected to the bus, the second switching module comprising:
a second switching element electrically connected to the first side; and
a fourth switching element electrically connected to the second side and the second switching element, wherein the second switching element is electrically connected to the fourth switching element at a second input node that is between the second switching element and the fourth switching element;
an energy storage system configured to be connected in parallel with the load, wherein the energy storage system comprises:
a first energy storage element electrically connected to the first side;
a second energy storage element electrically connected to the second side and to the first energy storage element, wherein the first energy storage element is electrically connected to the second energy storage element at an energy node that is between the first energy storage element and the second energy storage element; and
an energy filter system electrically connected to the energy node, wherein
the first input node is configured to electrically connect to a first phase of an alternating current (AC) power system, the second input node is configured to electrically connect to a second phase of the AC power system, and the energy filter system is configured to electrically connect to a third phase of the AC power system.

11. The rectifier system of claim 10, wherein
the first switching element comprises a first diode, the second switching element comprises a second diode, the third switching element comprises a third diode, and the fourth switching element comprises a fourth diode;
the first energy storage element comprises a first capacitor, and the second energy storage element comprises a second capacitor; and
the energy filter system comprises an inductor.

12. The rectifier system of claim 11, wherein
the first input node is electrically connected to an anode of the first diode and to a cathode of the third diode,
the second input node is electrically connected to an anode of the second diode and to a cathode of the fourth diode,
the first capacitor is electrically connected to a cathode of the first diode and to a cathode of the second diode, and
the second capacitor is electrically connected to an anode of the third diode and to an anode of the fourth diode.

13. The rectifier system of claim 11, wherein
the first input node is electrically connected to a cathode of the first diode and to an anode of the third diode,
the second input node is electrically connected to a cathode of the second diode and to an anode of the fourth diode,
the first capacitor is electrically connected to an anode of the first diode and to an anode of the second diode, and
the second capacitor is electrically connected to a cathode of the third diode and to a cathode of the fourth diode.

14. The rectifier system of claim 11, wherein the first capacitor and the second capacitor have the same capacitance value.

15. The rectifier system of claim 10, wherein a voltage across the energy storage system is at least two times greater than a line-line input voltage, wherein the line-line input voltage is a voltage between any two of the three phases of the AC power system.

16. The rectifier system of claim 10, wherein, in operational use, a first phase input current flows at the first input node, a second phase input current flows at the second input node, and a third phase input current flows at the energy filter system; and
the energy filter system is configured to reduce a difference among an RMS value of the first phase input current, an RMS value of the second phase input current, and an RMS value of the third phase input current.

17. The rectifier system of claim 10, wherein, in operational use, an AC current flows in each of the first switching element, the second switching element, the third switching element, and the fourth switching element during a single power cycle; and
the energy filter system is configured such that substantially the same amount RMS current flows in each of the first switching element, the second switching element, the third switching element, and the fourth switching element during the single power cycle.

18. A method of determining a final inductance value of an inductor for a rectifier circuit, the method comprising:
accessing an initial inductance value of the inductor;
determining a first voltage across a capacitor at a first time, wherein the capacitor is electrically connected to the inductor, and to a plurality of switching modules that are each configured to be electrically connected to a phase of an alternating current (AC) power system;
determining a second voltage across the capacitor at a second time, wherein the second time occurs after the first time;
determining a difference between the first voltage and the second voltage;
if the difference between the first voltage and the second voltage is outside a pre-determined range, the method further comprises:
reducing the first voltage; and
determining a difference between two additional voltages after reducing the first voltage;
if the difference between the first voltage and the second voltage is within the pre-determined range, the method further comprises: comparing the electrical current in each switching module to the electrical current in the other switching modules;
if the root-mean-square (RMS) electrical current in the switching modules is similar to within a threshold difference, providing the initial inductance value as the final inductance value; and
if the RMS electrical current in the switching modules is not similar to within the threshold difference, reducing the initial inductance value until the RMS electrical current in the switching modules is similar to within the threshold difference.

19. The method of claim 18, wherein the pre-determined range is a range of values between a first number that is less than zero and a second number that is greater than zero, and the threshold difference is a non-zero number.

20. The method of claim 18, wherein the pre-determined range includes only zero, and the threshold difference is zero.

21. The method of claim 18, wherein the first voltage is the voltage across the capacitor at a beginning of a power cycle of the AC power system, and the second voltage is the voltage across the capacitor at an end of the power cycle of the AC power system.

22. The method of claim 18, wherein the two additional voltages comprise the reduced first voltage another instance of the second voltage.
